(19) United States
(12) Patent Application Publication
(10) Pub. No.: US 2011/0107904 A1
(43) Pub. Date: May 12, 2011

(54) Synergistically-Layered Armor Systems and Methods for Producing Layers Thereof

(75) Inventors: Douglas T. Queheillalt, Charlottesville, VA (US); Haydn N.G. Wadley, Keswick, VA (US)

(73) Assignee: UNIVERSITY OF VIRGINIA PATENT FOUNDATION, Charlottesville, VA (US)

(21) Appl. No.: 12/673,647

(22) PCT Filed: Aug. 15, 2008
(86) PCT No.: PCT/US08/73377

§ 371 Date: Feb. 16, 2010

Related U.S. Application Data
(60) Provisional application No. 60/964,858, filed on Aug. 15, 2007.
(60) Provisional application No. 60/995,155, filed on Sep. 25, 2007.
(60) Provisional application No. 60/998,467, filed on Oct. 11, 2007.

(51) Int. Cl. F41H 5/04; B29C 65/56

(52) U.S. Cl. 89/36.02; 264/249; 89/904; 89/906; 89/907; 89/910; 89/930; 89/908

(57) ABSTRACT

The armor system according to the present invention also exploits synergistic multi-layering to provide different properties as a function of depth within a sandwich panel. Various embodiments of the invention include a combination of composite sandwich topology concepts with hard, strong materials to provide structures that (i) efficiently support static and fatigue loads, (ii) mitigate the blast pressure transmitted to a system that they protect, (iii) provides very effective resistance to projectile penetration, and (iv) minimizes shock (stress wave) propagation within the multi-layered armor sandwich structure. By using small pieces of highly constrained ceramic, the concept has significant multi-hit potential.

### CROSS-REFERENCE TO RELATED APPLICATIONS

This application claims benefit under 35 U.S.C. §119(e) to
U.S. Provisional Patent Application Ser. No. 60/964,858 filed on Aug. 15, 2007, and to
U.S. Provisional Patent Application Ser. No. 60/995,155 filed on Sep. 25, 2007, and to
U.S. Provisional Patent Application Ser. No. 60/998,467 filed on Oct. 11, 2007,
   which are hereby incorporated by reference in their entireties.

### BACKGROUND OF THE INVENTION

Modern armor used for vehicle, equipment, and structural protection must be capable of defeating a variety of ballistic and blast threats at the lowest possible mass and volume per unit area. One form of a ballistic threat can be categorized as a kinetic energy threat. A kinetic energy threat is one where penetration is achieved by an inert projectile, by virtue of the fact that it possesses kinetic energy. The kinetic energy of the projectile is acquired at launch, normally by a gun. Another type of ballistic threat is that of fragments. Fragments acquire kinetic energy as the result of an explosive event.

In either case, these threats have been developed to cause injury or damage to personnel, land vehicles, ships, aircraft and structures. The impact of inert ballistic projectiles and fragments can cause extreme localized damage to structural targets. Therefore, providing adequate protection to personnel and equipment within structural targets against projectiles and fragments is of the utmost importance in protective design.

Attempts have been made to address these problems by using monolithic steel plates made of rolled homogenous armor (RHA). Attempts have also been made to use aluminum and titanium alloys as armor materials.

However, as discussed above, modern armor should also provide a mechanism to catch small, slow moving fragments that might penetrate the system or that might be created by shock wave reflections (spalling). Attempts to solve such problems have included the addition of woven (ballistic) fabrics to the back of metal armor plates.

A composite armor with a higher mass and volumetric efficiency is desirable. Attempts have been made to add ceramics, such as alumina, silicon carbide, and boron carbide, to the front of metal or fiber-reinforced armor plates. Information relevant to such attempts can be found in the following references, which are not admitted to be prior art with respect to the present invention by inclusion in this section:
(1) Hard Faced Plastic Armor (U.S. Pat. No. 3,516,898, Jun. 23, 1970);
(2) Composite Armor Structure (U.S. Pat. No. 3,962,976, Jun. 15, 1976)

However, these attempts suffer from one or more of the following disadvantages, which are not admitted to have been known in the art by inclusion in this section:
(1) Ceramic plates are often unable to sustain performance and defeat multiple impacts by high velocity projectiles;
(2) Large areas of ceramic tiles tend to shatter completely when hit by a projectile, often rendering the composite armors unable to defeat a second projectile impacting close to a preceding impact;
(3) Sympathetic shattering of adjacent ceramic sections can also occur, further increasing the danger of penetration by subsequent impacts.

Confining the ceramic or containing it under compressive stress also can be highly beneficial. Attempts have been made to contain the ceramic using polymer, glass or carbon fiber fabrics. Constraining the movement and ejection of the ceramic as it is fractured or pulverized during an impact event is also desirable. Attempts also have been made to contain ceramic using polymer, glass or carbon fiber fabrics sometimes infiltrated with polymeric matrices that are wrapped around the ceramic. A composite armor known as Chobham armour developed in the 1960s at the British tank research center in Surrey, England, represents one attempt to address these problems. Some more sophisticated systems have attempted to add passive damping layers to mitigate shock propagation and to reduce ceramic fracture.

Further attempts have been made to defeat shaped charges and projectiles, to slow down the motion of armor cover plates, to attenuate the transmitted shock waves and associated reflected waves by means of crushing, refraction, reflection and viscoelastic phenomena, to minimize energy transfer and the propagation of stress waves that prematurely fracture or destroy successive armor layers upon ballistic impact, and to provide a lightweight, structurally rigid air gap material that isolates and dissipates shock (stress wave propagation) and allows for the integral bonding of multiple armor layers. Information relevant to these attempts can be found in the following references, which are not admitted to be prior art with respect to the present invention by inclusion in this section:
(1) Composite Floor Armor for Military Tanks and the Like (U.S. Pat. No. 4,404,889, Sep. 20, 1983)
(2) Impact Absorbing Armor (U.S. Pat. No. 5,349,893, Sep. 27, 1994)

Information relevant to attempts to provide lightweight sandwich panel structures consisting of low density cores and solid face sheets, which maintain a robust connection between the cellular core and the face sheets during deformation can be found in the following references, which are not admitted to be prior art with respect to the present invention by inclusion in this section:
(1) Qiu, X., Deshpande, V. S., and Fleck, N. A., 2003. Finite element analysis of the dynamic response of clamped sandwich beams subject to shock loading. European Journal of Mechanics—A/Solids 22, 801-814;
(2) Xue, Z., and Hutchinson, J. W., 2003. Preliminary assessment of sandwich plates subject to blast loads. International Journal of Mechanical Sciences 45, 687-705. Fleck and Deshpande, 2004;
(3) Rabczuk, T., Samaniego, E., and Belytschko, T., 2007. Simplified model for predicting impulsive loads on submerged structures to account for fluid-structure interaction. International Journal of Impact Engineering 34, 163-177;
(4) Xue, Z., and Hutchinson, J. W., 2004. A comparative study of impulse-resistant metal sandwich plates. International Journal of Impact Engineering 30, 1283-1305;
(5) Deshpande, V. S., and Fleck, N. A., 2005. One-dimensional response of sandwich plates to underwater shock loading. Journal of the Mechanics and Physics of Solids 53, 2347-2383. Hutchinson and Xue, 2005;
(6) Qiu, X., Deshpande, V. S., and Fleck, N. A., 2005. Impulsive loading of clamped monolithic and sandwich beams over a central patch. Journal of the Mechanics and Physics of Solids 53, 1015-1046. Liang et al., 2006;
(7) McShane, G. J., Radford, D. D., Deshpande, V. S., and Fleck, N. A., 2006. The response of clamped sandwich plates with lattice cores subjected to shock loading. European Journal of Mechanics—A/Solids 25, 215-229;
(8) Radford, D. D., Fleck, N. A., and Deshpande, V. S., 2006a. The response of clamped sandwich beams subjected to shock loading. International Journal of Impact Engineering 32, 968-987;
(9) Radford, D. D., McShane, G. J., Deshpande, V. S., and Fleck, N. A., 2006b. The response of clamped sandwich plates with metallic foam cores to simulated blast loading. International Journal of Solids and Structures 43, 2243-2259;
(10) Rathbun, H. J., Radford, D. D., Xue, Z., He, M. Y., Yang, J., Deshpande, V., Fleck, N. A., Hutchinson, J. W., Zok, F. W., and Evans, A. G., 2006. Performance of metallic honeycomb-core sandwich beams under shock loading. International Journal of Solids and Structures 43, 1746-1763.

However, these references suffer from the disadvantage that the structures all possess relatively low in-plane stretch resistance. This disadvantage is not admitted to have been known in the art by inclusion in this section.

Further information relevant to attempts to utilize cellular materials for blast and impact energy absorption can be found in U.S. patent application Ser. No. 10/522,068 and corresponding PCT International Application No. PCT/US2003/023043 entitled Cellular Materials and Structures for Blast and Impact Mitigation in Structures, U.S. patent application Ser. No. 10/479,833 and corresponding PCT International Application No. PCT/US02/17942 entitled Multifunctional Periodic Cellular Solids and the Method of Making the Same, and U.S. patent application Ser. No. 10/545,042 and corresponding PCT International Application No. PCT/US2004/004608 entitled Methods for Manufacture of Multilayered Multifunctional Truss Structures and Related Structures Therefrom, each incorporated by reference herein in their entireties.

For the foregoing reasons, there is a continuing need for armors that can be easily modified to provide protection against a wide variety of threats, and to provide continuing protection after multiple impacts.

### BRIEF SUMMARY OF THE INVENTION

A first embodiment of the present invention relates to a synergistically-layered armor system comprising a plurality of layers, wherein at least one layer comprises a plurality of ceramic elements confined within a cellular structure comprising a plurality of voids, wherein the ceramic elements are individually isolated with the plurality of voids.

A second embodiment of the present invention relates to a synergistically-layered armor system comprising a plurality of synergistic layers, wherein at least one modular layer comprises a lattice-based truss core structure.

A third embodiment of the present invention relates to a synergistically-layered armor system comprising a plurality of synergistic modular layers, wherein at least one modular layer comprises: a structure panel having a front plate and a back plate; a corrugating element positioned between and adjoining the front plate and the back plate, wherein the corrugating element defines a plurality of voids; and at least one fill material filling the plurality of voids.

A fourth embodiment of the present invention relates to a method for producing an armor layer, the method comprising: providing a first plurality of triangular prism elements, each having an apex and a base; aligning the first plurality of triangular prism elements such that the bases are coplanar and the apexes are parallel to one another; placing a polymer-based fiber composite layer on the apexes of the first plurality of triangular prism elements; providing a second plurality of triangular prism elements, each having an apex and a base; aligning the second plurality of triangular prism elements such that the bases are coplanar and the apexes are parallel to one another; pressing the apexes of the second plurality of triangular prism elements against the polymer-based fiber composite layer to deform the polymer-based fiber composite layer until the apexes of the second plurality of triangular prism elements is coplanar with the bases of the first plurality of triangular prism elements; and thereby forming an armor layer.

### BRIEF DESCRIPTION OF THE DRAWINGS

These and other features, aspects, and advantages of the present invention will become better understood with reference to the following description and appended claims, and accompanying drawings wherein:

FIG. 1 shows an example of a multilayered composite armor based upon cellular materials concepts, particularly useful on vehicles where lightweight solutions are required;

FIGS. 2(a) and 2(b) are schematic illustrations of a cross section of a composite and ceramic ballistic armor according to another embodiment, showing the impact of a projectile or fragment near a) the base and b) the apex of the triangular ceramic elements;

FIGS. 3(a) and 3(b) show a multilayered cross section of two variants of the composite and ceramic ballistic armor of FIGS. 2(a)-2(b), showing the impact of a projectile or fragment near the apex of the triangular ceramic elements;

FIGS. 4(a), 4(b), and 4(c) show illustrations of three variations of the prismatic ceramic components: a) a single ceramic prism, b) a component ceramic prism with normal edges and c) a component ceramic prism with sloped edges;

FIG. 5 shows a schematic illustration of an array of single ceramic prisms;

FIGS. 6(a) and 6(b) are schematic illustrations of the arrays of component ceramic prisms with normal edges in an a) non-staggered and b) staggered arrangement;

FIGS. 7(a) and 7(b) are schematic illustrations of the arrays of component ceramic prisms with sloped edges in an a) non-staggered and b) staggered arrangement;

FIGS. 8(a) and 8(b) are schematic illustrations of the armor design concept envisioned here showing various layers of the structure; damping layer, hard ceramic layer (with and without containment), fiber reinforced polymer composite sandwich structure, shock damping material within the open region of the sandwich structure and a woven-fiber ballistic spall layer;

FIG. 9 is a schematic illustration of the armor concept with a fiber reinforced polymer composite square honeycomb sandwich structure;

FIG. 10 is a schematic illustration of the armor concept with a fiber reinforced polymer composite lattice based truss sandwich structure; and

FIG. 11 shows the normalized (a) compressive and (b) shear peak strengths of the 304 stainless steel hollow pyramidal lattice structures compared to other 304 stainless steel structures with honeycomb, prismatic and solid truss lattice topologies.

### DETAILED DESCRIPTION OF THE INVENTION

The present invention may be understood more readily by reference to the following detailed description of preferred embodiments of the invention as well as to the examples included therein. In the following detailed description and in the claims which follow, reference will be made to a number of terms which shall be defined to have the following meanings:

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The armor system of the present invention relates to the use of a plurality of cellular composite armor layers in combination with crushable cellular materials for energy dissipation and shock mitigation. The armor system of the present invention preferably utilizes polymer based composites core combinations available from the lattice structure family of materials with hard ceramics and shock-damping/ballistic fabrics. According to the present invention, superior armor design can be created which also functions as a structural element of a combat vehicle. These structural components then provide a light weight solution against the various blast and ballistic threats that confront combat vehicles.

The armor system according to the present invention also exploits synergistic multi-layering to provide different properties as a function of depth within a sandwich panel. Various embodiments of the invention include a combination of composite sandwich topology concepts with hard, strong materials to provide structures that (i) efficiently support static and fatigue loads, (ii) mitigate the blast pressure transmitted to a system that they protect, (iii) provides very effective resistance to projectile penetration and (iv) minimizes shock (stress wave) propagation within the multi-layered armor sandwich structure. By using small pieces of highly constrained ceramic, the concept has significant multi-hit potential.

The armor system according to the present invention comprises a plurality of solid layers. Each of the solid layers can be a monolithic material. Preferable monolithic materials include metal alloys, polymer, preferably tough polymers, high strength ceramics and composites. Preferable composites include fiber reinforced polymer composites, metal backed ceramic systems, sandwich panels with ceramics inserted in the internal void spaces, and other composite materials. The solid layers can be made homogeneously of the same material or of multiple materials. Multiple materials can be used in the solid layers to grade the response to an impact as a function of depth from the front face, i.e., each layer is designed to perform a specific function.

The armor system according the present invention further comprises a cellular sandwich structure that mitigates shock wave propagation and helps to manipulate the mechanisms of projectile penetration so that energy dissipation is maximized. The solid layers are interspaced with the cellular sandwich structure. Preferably, the cellular sandwich structure is a fiber-reinforced polymer based cellular sandwich structure. The plurality of solid layers are well bonded to intervening layers of the cellular sandwich structure.

The inventive armor system reduces or eliminates spalling at the back surface of layers impacted by high velocity ballistic threats. However, ballistic fabrics are preferably incorporated at the back of the cellular sandwich structure to ensure that all fragments generated at any of the various layers are caught.

One embodiment of the present invention relates to a synergistically-layered armor system comprising a plurality of layers, wherein at least one layer comprises a plurality of ceramic elements confined within voids of a cellular structure comprising a plurality of voids, wherein the ceramic elements are individually isolated within the plurality of voids. Preferably, the ceramic elements are shaped as triangular prisms, each having an apex, and a base. Preferably, the ceramic elements shaped as triangular prisms are arranged in a staggered formation such that the apex of each ceramic element is coplanar with the bases of two adjacent ceramic elements. Preferably, the ceramic elements are segmented. In one preferred embodiment, the cellular structure is a square honeycomb core structure.

Another embodiment of the present invention relates to a synergistically-layered armor system comprising a plurality of synergistic modular layers, wherein at least one modular layer comprises: a structure panel having a front plate and a back plate; a corrugating element positioned between and adjoining the front plate and the back plate, wherein the corrugating element defines a plurality of voids; and at least one fill material filling the plurality of voids. Preferably, the structure panel bears the structural loads of a vehicle. Preferably, the structure panel is fabricated from a metal alloy. Preferably, the structure panel is fabricated from an aluminum alloy. Preferably, each of the plurality of voids defined by the corrugating element are shaped as triangular prisms. Preferably, the at least one fill material is at least one ceramic prism. Preferably, the at least one fill material is a plurality of ceramic prisms arranged in a staggered formation. Preferably, the armor system further comprises an additional modular layer, wherein the additional modular layer is a hard ceramic layer affixed to the front plate. Particularly preferably, the hard ceramic layer is encapsulated by a fiber reinforced polymer composite sandwich structure. Preferably, the armor system further comprises an additional modular layer, wherein the additional modular layer is a spall shield affixed to the back plate. Preferably, the armor system further comprises additional modular layers, wherein the first additional modular layer is a central layer having a front face and a back face, wherein the second additional modular layer is a first cellular structure connected to the front face, and wherein the third additional modular layer is a second cellular structure connected to the back face. Particularly preferably, the first cellular layer has a multilayered pyramidal lattice structure. Particularly preferably, the first cellular layer and the second cellular layer have multilayered pyramidal lattice structures. Particularly preferably, the armor system further comprises a fourth additional modular layer, wherein the fourth additional modular layer is a cellular sandwich panel affixed to the first cellular structure, wherein the cellular sandwich panel comprises: a front plate and a back plate; a corrugating element positioned between and adjoining the front plate and the back plate, wherein the corrugating element defines a plurality of voids; and at least one fill material filling the plurality of voids.

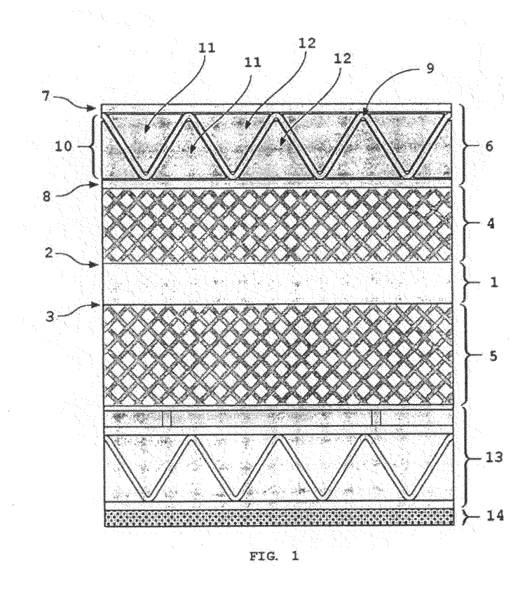

FIG. 1 shows an exemplary embodiment of the armor according to the present invention. The armor exemplified in FIG. 1, has a total thickness of 9 to 10 inches. The armor system exemplified in FIG. 1, comprises a central layer (1). The central layer can be composed of a solid plate of an aluminum alloy. It is preferable to employ a grade of aluminum that has a high ballistic mass efficiency, is easy to metallurgically form and join, i.e., is simple to manufacture, and has a good resistance to corrosion and fatigue loading. Aluminum is the preferred metal alloy, however, it is envisioned that any metal alloy with favorable ballistic characteristics such as, but not limited to steels, titanium alloys and like materials may be used.

The central layer (1) has a front face (2) and a back face (3). The front face (2) is connected to a first cellular structure (4). The back face (3) is connected to a second cellular structure. As exemplified in FIG. 1, the first cellular structure (4) and the second cellular structure (5) are preferably multilayered pyramidal lattice structures. The first and second cellular structures can, however, be configured as other cellular structures having high specific damping (shock reducing) properties.

The thicknesses of these three layers, i.e. the central layer (1), the first cellular structure (4), and the second cellular structure (5) can be varied to match application of the armor to a threat of concern. Similarly, the alloys used to make these layers can be varied.

Attached to the first cellular structure (4) is a cellular sandwich panel (6). Cellular sandwich panel (6) preferably comprises an aluminum alloy; however, any metal alloy with favorable ballistic characteristics such as, but not limited to steels, titanium alloys and like materials also may be used. Cellular sandwich panel (6) also can be fabricated from fiber reinforced polymer based composites.

Cellular sandwich panel (6) has a top panel (7) and a bottom panel (8), which are separated by a corrugating element (9). The separation between top panel (7) and bottom panel (8) defines a core (10) having a plurality of voids (11). Materials of construction and thicknesses of top panel (7), bottom panel (8), core (10) all can be adjusted to meet specific ballistic performance goals. Cellular sandwich panel (6) has a core topology, and a mass per unit area, which can also be adjusted to meet specific ballistic performance goals. FIG. 1 also exemplifies fill material (12) that can be inserted into voids (11). In the example shown, voids (11) are filled with a hard material such as a ballistic grade of ceramic or super hard metal or a tough metal ceramic armor. Alternating regions of metal and ceramic can provide a spatially varying hardness that can be used to heavily deform a large projectile, causing it to dissipate kinetic energy and to begin to break-up into smaller, spatially separated fragments.

Cellular sandwich panel (6) also can be fabricated from corrugated cores, since they permit the simple incorporation of ceramic prisms or rectangular cross section prismatic structures and are simple to make by extrusion. Sandwich panels can also be extruded with circular or elliptical holes which are amenable for the incorporation of cylindrical ceramics.

Preferably, the armor system of the present invention, exemplified in FIG. 1, is adapted to allow for modular build-up of protective layers. This preferable modular build-up allows any variety of layers to be added quickly to meet changing threat scenarios.

In the embodiment of the armor system illustrated in FIG. 1, modular layering is facilitated by the use of a structure panel (13). Structure panel (13) is preferably a strong stiff sandwich panel located at the back of the armor. Preferably, structure panel (13) is a multifunctional member that is a normal part of the structure of the object being fitted, such as a vehicle. Particularly preferably, structure panel (13) always remains attached to the vehicle and carries the majority of the vehicle's structural loads.

To provide modular layering, additional panels with metallurgically attached cellular cores can be added as needed to create the inventive armor system, illustrated in FIG. 1. Preferably, the armor system according the present invention is designed to exploit the unique behavior of each individual layer to create additive projectile-defeating mechanisms. Synergies between the layers are preferably exploited to significantly increase performance.

FIG. 1 further provides an example of synergistic function between the layers of the armor system according to the present invention, wherein cellular sandwich panel (6) has a particular core design. More specifically, the cellular sandwich panel (6) can contain specific weak directions at the metal-to-ceramic interfaces, which under shear loading cause a formation of a plug significantly larger than the diameter of the projectile impacting the panel (6). This plug will acquire some of the momentum and kinetic energy of the projectile so that the combined projectile-plus-plug is traveling much more slowly than the original projectile. The propagation of this large diameter plug is then hindered by the crushing and shearing resistance of the cellular structure beneath it, i.e., first cellular structure (4). The plug and projectile eventually impact the central layer (1), and cause it to suffer a bending deformation. This bending deformation is locally supported by second cellular structure (5), which reduces the likelihood of shear-off and enhances energy dissipation by plastic stretching of the central layer (1). If central layer (1) is penetrated, second cellular structure (5) provides additional deceleration forces to the projectile because of its controllably high resistance to lattice crushing.

Structure panel (13) comprises a metallic sandwich panel with a cellular core, similar to cellular sandwich panel (6). The cellular core of structure panel (13) is preferably filled with ceramics or other armor materials or with polymeric materials that are effective at defeating slow-moving fragments.

Finally, spall shield (14) is optionally attached to the back of this structure and is shown in FIG. 1. Spall shield (14) can be used to mitigate the propagation of shocks in the lateral direction or to catch fragments that may have penetrated the armor system.

First cellular structure (4) and second cellular structure (5) serve multifunctional roles in the armor system illustrated in FIG. 1. First cellular structure (4) and second cellular structure (5) dissipate an impacting projectile's kinetic energy by crushing, provide highly effective shock mitigation in both the through thickness and transverse directions and maintain the space between the primary layers, i.e. cellular sandwich panel (6), central layer (1), and structure panel (13), of the armor system.

In another embodiment of the armor system according to the present invention, first cellular structure (4) and second cellular structure (5) are partially or fully filled with polymeric materials or ceramic-polymeric mixtures or liquid slurries containing void spaces or any other materials system which has the effect of increasing the damping (shock reducing) and ballistic resistance properties of these layers.

In FIG. 1, the mass per unit area, i.e., the specific mass, in units of pounds per square foot for each of the layers, is as follows: the specific mass of central layer (1) is 15 pounds per square foot; the specific mass of first cellular structure (4) is 10 pounds per square foot; the specific mass of second cellular structure (5) is 15 pounds per square foot; the specific mass of cellular sandwich panel (6) is 20 pounds per square foot; the specific mass of structure panel (13) is 20 pounds per square foot; and the specific mass of spall shield (14) is 3 pounds per square foot. The invention also envisages much lighter solutions made using thinner and/or fewer layers. Much heavier systems also can be made that would be useful against very high kinetic energy and impulse threats.

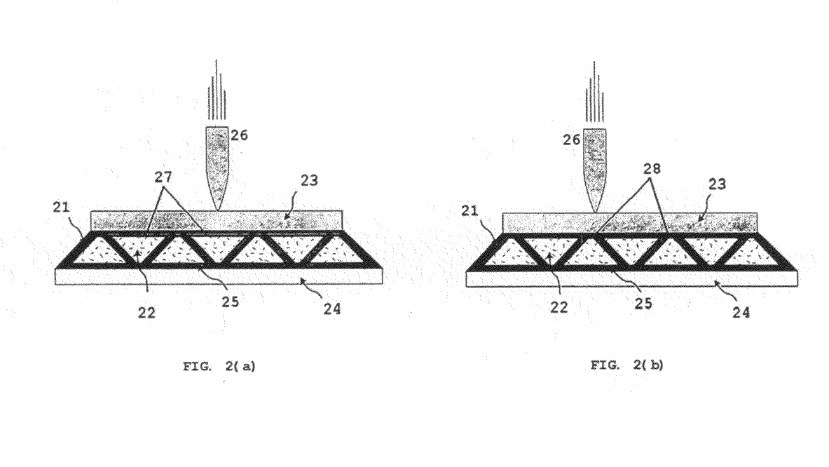

Various embodiments of the present invention provide a composite armor structures (and related method of use and manufacture) which are constructed from fiber-based composite sandwich structures containing ceramic components within the open channels of the sandwich structure. The ceramic components may serve a dual purpose: they provide the structural integrity needed during the composite processing stages of fabrication, and they are rigidly confined by the woven fabric components. The process results in an integral composite armor suitable for curtailing projectile and fragment impacts. FIG. 2 shows another example of a composite and ceramic ballistic armor in accordance with the concepts of the present invention.

FIGS. 2(a) and 2(b) illustrate a composite and ceramic ballistic armor in accordance with another embodiment of the invention. As shown, this embodiment comprises a prismatic sandwich structure (21), preferably a fiber-reinforced composite component. The fiber reinforced composite components can be, but are not limited to, glass, ceramic, graphite fibers infused with a polymer matrix such as, but not limited to, vinyl ester resins, epoxies, toughened epoxies, etc.

The armor further comprises ceramic elements (22), which are preferably triangular shaped ceramic prisms. The ceramic elements (22) are interspaced within the prismatic sandwich structure (21). The ceramic elements (22) can be, but are not limited to, aluminum oxide, silicon carbide, boron carbide, etc.

Preferably, the armor further comprises a damping layer (23) on the impact side of the composite armor structure. The damping layer (23) preferably comprises a rubber or polymeric material.

Preferably, the armor further comprises at least one woven ballistic fabric spall layer (24) on the backside of the composite armor structure. Preferably, the armor further comprises a shock isolation coating (25) encasing the ceramic prism structure (21). The shock isolation coating (25) can comprise a rubber, an elastomer, or a polymer. The composite armor structures can be made from any combination of the previously mentioned variations.

The preferred method of manufacturing the armor according to the present invention is vacuum assisted resin transfer molding, which may or may not include a pressurization step to ensure infusion homogeneity. However, upon reviewing the present disclosure, persons of ordinary skill in the art will appreciate that other methods may be implemented as well.

In FIG. 2(a), the impact of a projectile (26) or fragment on the composite armor structure occurs near a base (27) of the prism structure (21). In FIG. 2(b) the impact of projectile (26) occurs near an apex (28) of the triangular shaped ceramic elements. In the case of impact on a base (27) of a triangular ceramic element, the projectile or fragment is defeated by crushing of the projectile by ceramic material (22). In the case of impact on or near an apex (28) of a triangular ceramic element, the projectile or fragment is defeated by tilting or turning of the projectile by the armor.

In particularly preferred embodiments of the present invention, the segmented and isolated nature of the ceramic elements (22) leads to an armor structure that performs equally or better than a conventionally backed ceramic tile impacted by a single projectile or fragment event and better than a conventionally backed ceramic tile impacted by multiple projectile or fragment events.

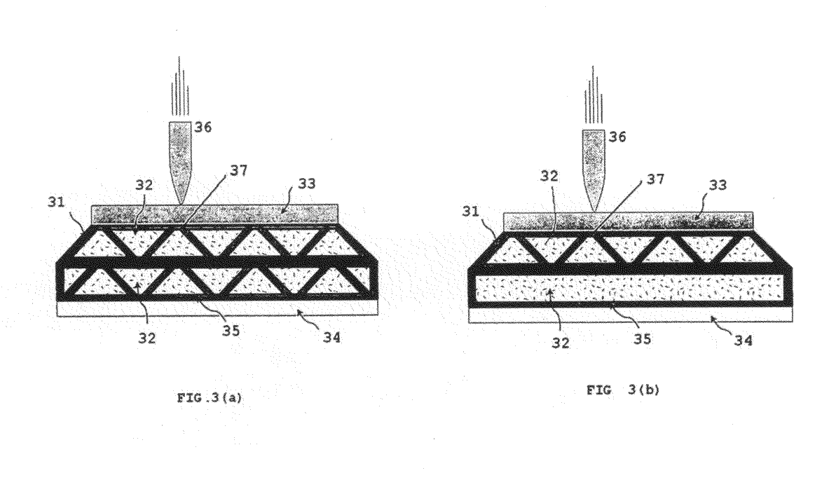

FIGS. 3(a) and 3(b) show an alternate configuration of a multilayered armor system similar to FIGS. 2(a)-2(b), which comprises multiple layers of ceramic elements (32). In FIG. 3(a) the ceramic elements (32) are layered in parallel. In FIG. 3(b) the ceramic elements (32) are layered perpendicularly (i.e., the bottom layer 32 in FIG. 3(b) is turned 90 degrees with respect to the bottom layer 32 of FIG. 3(a)). The ceramic elements are interposed within a prismatic sandwich structure (31). Like the armor illustrated in FIGS. 2(a)-2(b), the multilayered armor illustrated in FIGS. 3(a) and 3(b) further comprises a damping layer (33), a woven ballistic fabric spall layer (34), and a shock isolation coating (35).

FIGS. 3(a) and 3(b) also show the impact of a projectile (36) or fragment near an apex (37) of the triangular shaped ceramic elements (32). As the projectile (36) is tilted or turned by the upper layer of ceramic elements, it propagates between the ceramic elements, decreases in velocity and impacts the lower layer of ceramic providing a robust system.

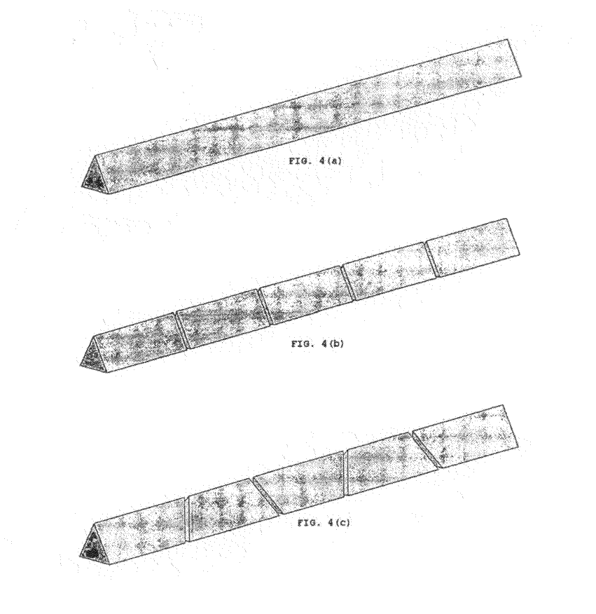

FIGS. 4(a), 4(b), and 4(c) show several configuration variations of the prismatic ceramic components in accordance with the second embodiment of the invention. FIG. 4(a) shows a single, continuous ceramic prism. FIG. 4(b) shows a component ceramic prism with normal edges. FIG. 4(c) shows a component ceramic prism with sloped edges. The simplest form is shown in FIG. 4(a) where each ceramic prism consists of a single, homogeneous structure. FIG. 4(b) and (c) show variants in which a single ceramic prism can be constructed from smaller sub-scale components. These are shown for edges which are normal to the prism length and edges which are sloped or angled with respect to the prism length. The smaller ceramic pieces illustrated in FIG. 4(b) and (c) can be adhesively joined, forming a structure similar to that of FIG. 4(a).

The use of adhesively bonded sub-scale ceramic prisms is two-fold in purpose. The acoustic impedance mismatch and physical separation of the ceramic components by the adhesive layer plays a role in reducing the propagation of stress waves, and retards crack propagation.

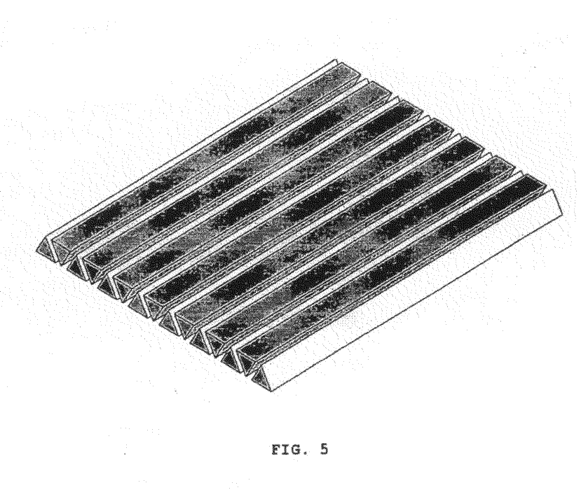

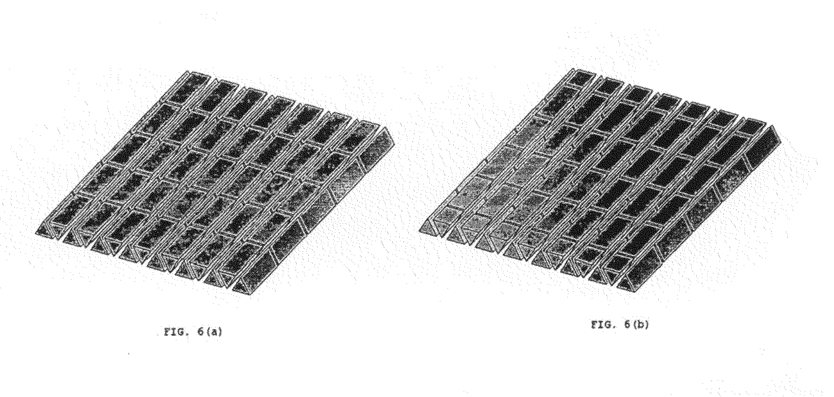

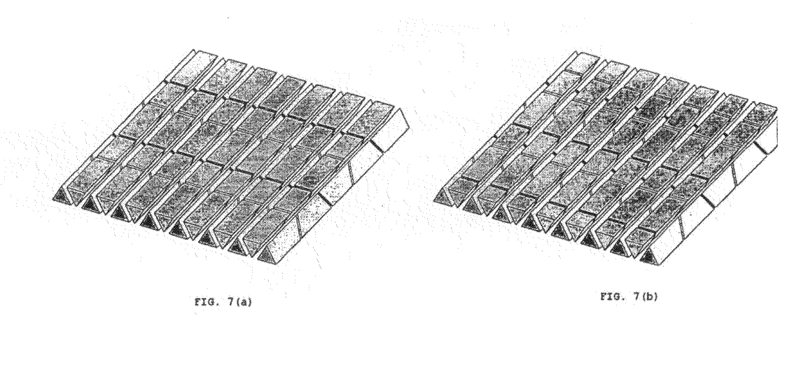

FIG. 5 shows an example of the simplest array of single ceramic prisms. FIGS. 6(a) and 6(b) respectively show example arrays of component ceramic prisms with normal edges in a non-staggered and staggered arrangement. FIGS. 7(a) and 7(b) respectively show example arrays of component ceramic prisms with sloped edges in additional non-staggered and staggered arrangements. The unique benefits of the variations shown in FIGS. 6 and 7 include the fact that impact damage is localized within the individual components and thus the composite ceramic armor structures possess good multi-hit capabilities due to the unique confinement and isolation of the ceramic components.

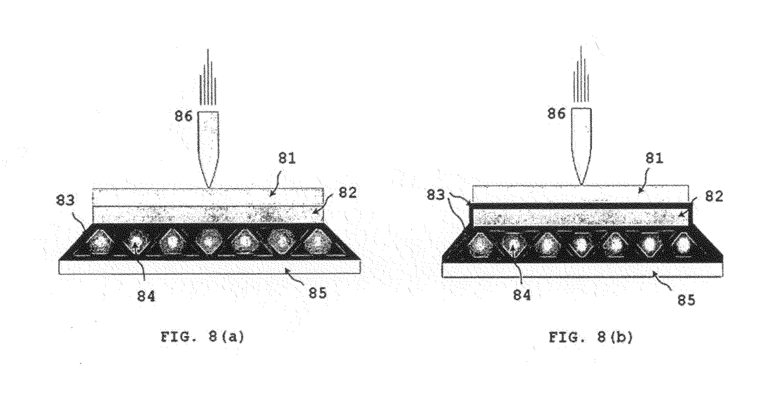

FIGS. 8(a) and 8(b) show an armor design concept in accordance with yet another embodiment of the present invention, showing various layers of the structure. The various layers of the structure include a damping layer (81), hard ceramic layer (82), fiber-reinforced polymer composite sandwich structure (83), shock damping material (84) within the open region of the sandwich structure and a woven-fiber ballistic spall layer (85).

FIG. 8(b) shows a hard ceramic layer (82) with containment in fiber-reinforced polymer composite sandwich structure (83). FIG. 8(a) shows ceramic layer (82) without containment in the sandwich structure (83). A projectile or fragment (86) is shown impacting damping layer (81).

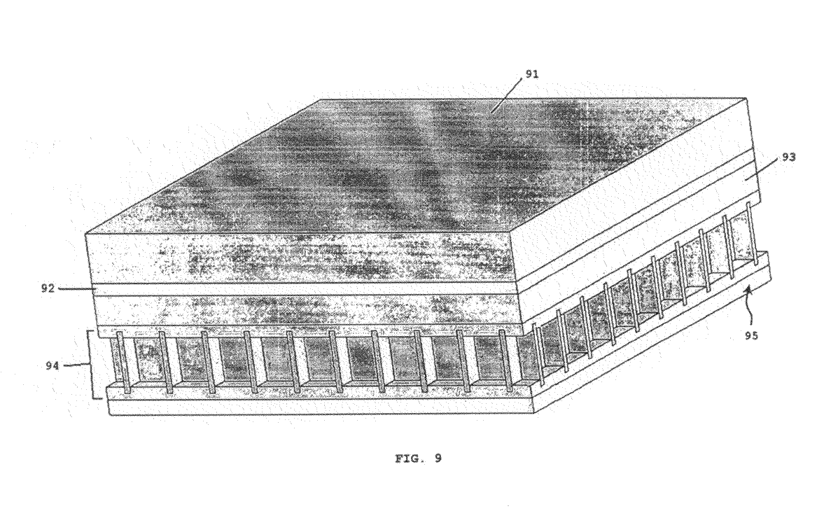

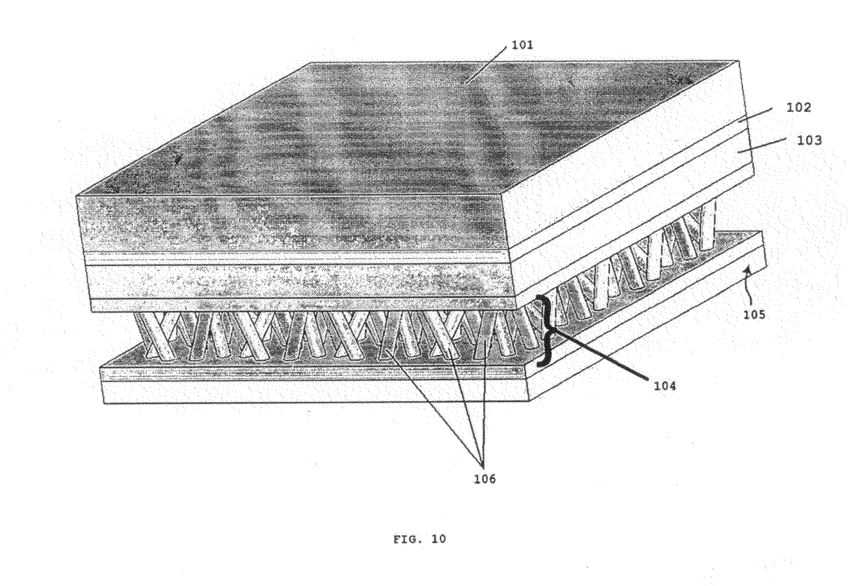

FIGS. 9 and 10 show variations of the armor structure in accordance with the invention, showing a square honeycomb and a lattice-based truss core, respectively.

FIG. 9 shows a variation of the armor structure with a square honeycomb sandwich core structure. FIG. 9 shows a damping layer (91) on top of a fiber-reinforced polymer composite (92), on top of a ceramic layer (93). Ceramic layer (93) is formed on top of a square honeycomb sandwich structure (94), which is backed with a woven-fiber spall layer (95).

FIG. 10 shows a variation of the armor structure with a lattice-based truss sandwich core structure. Cores based on lattice truss members are preferably constructed from hollow tubes. FIG. 10 shows a damping layer (101) formed on top of a fiber reinforced polymer composite (102), which is formed on top of a ceramic layer (103). Ceramic layer (103) is formed on top of a lattice based truss sandwich core structure (104), which is backed with a woven-fiber spall layer (105). The lattice-based truss sandwich core structure (104) is constructed from hollow tubes (106).

In another embodiment of the present invention, it is envisioned that the lattice structure shown in FIG. 10 may be constructed from hollow metal lattice trusses. It has been recently reported that some collinear lattice truss sandwich structures with hollow trusses appear significantly stronger than solid truss counterparts of similar relative density (Queheillalt and Wadley, 2005, Rathbun et al., 2006). This increase in strength was achieved by stabilization of the trusses against global buckling which is controlled by the radius of gyration, \sqrt{I/A}, of the truss. Here I is the second area moment of inertia and A is the cross sectional area of the truss member (Gere and Timoshenk, 1984). Increasing the value of the radius of gyration by increasing the second moment is a well known means for increasing a columns resistance to buckling. In tubes of constant mass, this is accomplished by increasing the tube radius and decreasing the wall thickness. The collinear lattice has a highly anisotropic in plane response and so interest has arisen in the application of the approach to pyramidal and tetrahedral lattices.

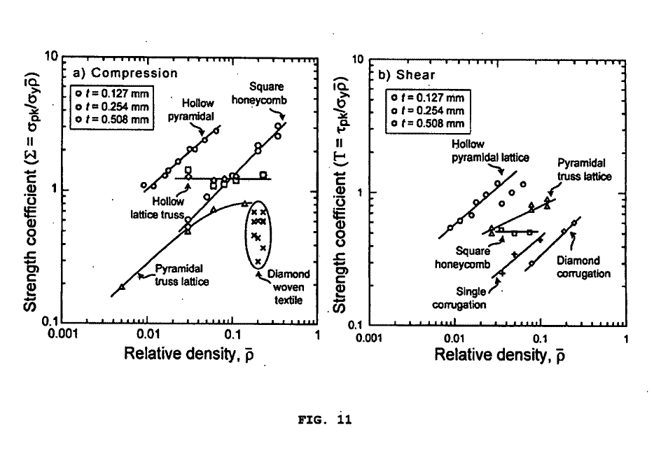

In a subsequent study (Queheillalt and Wadley, 2007) pyramidal lattice core sandwich structures with hollow trusses have been assembled from 304 stainless steel tubes and bi-layer face sheets and bonded using a vacuum brazing approach. Rigid, large interfacial area nodes between the trusses and face sheets could be made by this approach. This eliminated the nodal rotation and failure during in-plane shear loading that is often observed in low core density solid truss structures. The through-thickness compression and transverse shear stiffness and strengths of the hollow pyramidal lattice structure have been measured and compared with analytical predictions based upon plastic yielding and the various modes of lattice strut buckling. The compressive and shear strengths of hollow pyramidal lattices with relative densities of ˜1 to 6% were 3 to 5 times those of solid pyramidal lattices of equivalent relative density, as shown in FIG. 11. They also significantly exceed the strength of equal relative density honeycombs. The increased strength resulted from stabilization against buckling and could be controlled by modification of the radius of gyration of the struts for a fixed core relative density. This strengthening approach was accompanied by significant strength retention of the post buckled structures resulting in very high specific energy absorption. Therefore, these structures should provide a very rigid support system for the ceramic tile.

The ceramic tile components can be of any variety of oxides, nitrides, and/or carbides processed by hot pressing or reaction bonding/sintering methods. Aluminum oxide (Al₂O₃), silicon carbide (SiC) and boron carbide (B₄C) are the preferred armor ceramics of choice, but it is envisioned that any hard ceramic or polymer (e.g. polycarbonate) or metallic (e.g. maraging steel) composition could be used in this armor concept. The outer damping layer helps to reduce the initial shock imparted to the structure. Preferred damping materials are vinyls and urethanes and are well known to those skilled in the art of impact noise and structure borne vibration reduction. Small cell size metallic, polymeric and ceramic foams and multi-layered fabrics can also be used. The intermediate ceramic constraint sheet and tile isolation layer is preferably a fiber reinforced polymer composite, but it is envisioned this layer could consist of a metal alloy.

The fiber reinforced polymer-based composite sandwich structure itself provides certain unique characteristic features. Fiber reinforced polymer based composite sandwich structures polymer posses some of the highest specific stiffness and strength of any materials known to man and serves a multifunctional role in the armor design. It is envisioned that both the core topology and specific material the sandwich structure is constructed from can vary and are covered in this disclosure. Glass and carbon fiber reinforced materials are preferred, but it is envisioned other materials could be used. It provides a lightweight, rigid support for the hard ceramic layer and can also dissipate the projectiles kinetic energy by deforming and providing highly effective shock mitigation in both the through thickness and transverse directions. Polymeric materials and/or ceramic-polymeric mixtures or liquid slurries containing void spaces or any other materials system which have the effect of increasing the damping (shock reducing) and ballistic resistance properties of these layers and are effective at defeating slow moving fragments can also be added to the open regions within the system to modify ballistic responses and/or interact in beneficial ways to reduce shock wave propagation.

An optional spall shield can be attached to the back of this structure. It can be used to mitigate the propagation of shocks in the lateral direction or to catch fragments that may have penetrated the armor system. Woven fabric structures of Kevlar, Spectra or Dyneema are preferred; however any woven fabric structure that possesses sufficient ballistic resistance may be used.

Embodiments of the armor system according to the present invention provide a number of novel and non-obvious features, elements and characteristics, such as but not limited to, the use of a plurality of ceramic composite armor layers in combination with a rigid composite-based cellular sandwich for energy dissipation and shock mitigation.

The armor system of the present invention also relates to fiber composite based sandwich structures. Prismatic sandwich structures can be created by stitching a woven fabric core material to alternating woven fabric facesheets using a high density foam (polyurethane, etc.) shaped support within each linear channel to form the overall desired geometry of the core and sandwich structure. The woven fabric components of the resulting structure are preferably infused with an appropriate polymeric resin system, by means of vacuum assisted resin transfer molding.

Some armor systems according to the present invention comprise composite armor structures constructed from fiber based composite sandwich structures containing ceramic components within the open channels of the sandwich structure. The ceramic components serve a dual purpose: they provide the structural integrity needed during the composites processing stages of fabrication and are rigidly confined by the woven fabric components. The process results in an integral composite armor suitable for curtailing projectile and fragment impacts and possesses good multi-hit capabilities due to the unique confinement and isolation of the ceramic components.

Embodiments of the present invention relate to a process for producing an integral composite armor suitable for curtailing projectile and fragment impacts and possessing good multi-hit capabilities due to the unique confinement and isolation of ceramic components.

According to the process, ceramic components serve a dual purpose. First, ceramic components serve as the shape holding support structures during processing of polymer based fiber composite sandwich structures. Second, ceramic components provide the structural integrity needed during the composites processing stages of fabrication. The ceramic components are rigidly confined by the woven fabric components.

In summary, the systems and methods of various embodiments of the invention disclosed herein may comprise, but are not limited to: an armor design that may be based upon a plurality of solid layers interspaced with a fiber reinforced polymer based cellular sandwich structure. Each of the solid layers may be a monolithic material (e.g. such as a metal alloy, a polymer or a high strength ceramic) or a fiber reinforced polymer composite. The various solid layers are made of different materials used to grade the response as a function of depth from the front face, i.e. each layer is designed to perform a specific function. The plurality of layers are well bonded to each other and the fiber reinforced polymer based cellular structure that mitigates shock wave propagation and helps to manipulate the mechanisms of projectile penetration so that energy dissipation is maximized. This system also can be used to reduce or eliminate spalling at the back surface of layers impacted by high velocity ballistic threats. It should be appreciated that the system may also incorporate ballistic fabrics at the back of the sandwich structure to catch fragments generated at any of the various layers.

Although the present invention has been described in considerable detail with reference to certain preferred versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. A synergistically-layered armor system comprising a plurality of layers, wherein at least one layer comprises a plurality of projectile-resisting fill elements confined within voids of a cellular structure comprising a plurality of voids, wherein the fill elements are individually isolated with the plurality of voids.

2. The synergistically-layered armor system of claim 1, wherein the fill elements are shaped as triangular prisms, each having an apex, and a base.

3. The synergistically-layered armor system of claim 2, wherein the fill elements are ceramic elements shaped as triangular prisms are arranged in a staggered formation such that the apex of each ceramic element is coplanar with the bases of two adjacent ceramic elements.

4. The synergistically-layered armor system of claim 2, wherein the fill elements are segmented.

5. The synergistically-layered armor system of claim 1, wherein the cellular structure is a square honeycomb core structure.

6. The synergistically-layered armor system of claim 1, wherein the fill elements are metal elements.

7. The synergistically-layered armor system of claim 1, wherein the fill elements are ceramic elements and metal elements arranged in an alternating configuration within said voids.

8. A synergistically-layered armor system comprising:
a cellular core structure;
a ceramic layer formed on top of said cellular core structure;
a damping layer formed on top of said ceramic layer; and
a spalling layer formed on said cellular core structure opposite to said ceramic layer.

9. The synergistically-layered armor layer of claim 8, wherein said cellular core structure is a lattice-based truss core structure.

10. The synergistically-layered armor layer of claim 9, wherein said lattice-based truss core structure is constructed from hollow tubes.

11. The synergistically-layered armor layer of claim 8, wherein said cellular core structure is a square honeycomb core structure.

12. A synergistically-layered armor system comprising a plurality of synergistic modular layers, wherein at least one modular layer comprises:
a structure panel having a front plate and a back plate;
a corrugating element positioned between and adjoining the front plate and the back plate, wherein the corrugating element defines a plurality of voids; and
at least one fill material filling at least one of the plurality of voids.

13. The synergistically-layered armor system of claim 12, wherein the fill material is a metal material.

14. The synergistically-layered armor system of claim 12, further comprising a plurality of fill materials, wherein the fill materials are ceramic elements and metal elements arranged in an alternating configuration within said voids.

15. The armor system of claim 12, wherein the structure panel bears the structural loads of a vehicle.

16. The armor system of claim 12, wherein the structure panel is fabricated from a metal alloy.

17. The armor system of claim 16, wherein the structure panel is fabricated from an aluminum alloy.

18. The armor system of claim 12, wherein each of the plurality of voids defined by the corrugating element are shaped as triangular prisms.

19. The armor system of claim 18, wherein the at least one fill material is at least one ceramic prism.

20. The armor system of claim 18, wherein the at least one fill material is a plurality of ceramic prisms arranged in a staggered formation.

21. The armor system of claim 12, further comprising an additional modular layer, wherein the additional modular layer is a hard ceramic layer affixed to the front plate.

22. The armor system of claim 21, wherein the hard ceramic layer is encapsulated by a fiber reinforced polymer composite sandwich structure.

23. The armor system of claim 12, further comprising an additional modular layer, wherein the additional modular layer is a spall shield affixed to the back plate.

24. The armor system of claim 12, further comprising additional modular layers,
wherein the first additional modular layer is a central layer having a front face and a back face,
wherein the second additional modular layer is a first cellular structure connected to the front face, and
wherein the third additional modular layer is a second cellular structure connected to the back face.

25. The armor system of claim 24, wherein the first cellular structure layer has a multilayered pyramidal lattice structure.

26. The armor system of claim 24, wherein the first cellular layer and the second cellular layer have multilayered pyramidal lattice structures.

27. The armor system of claim 24, further comprising a fourth additional modular layer, wherein the fourth additional modular layer is a cellular sandwich panel affixed to the first cellular structure,
wherein the cellular sandwich panel comprises:
a front plate and a back plate;
a corrugating element positioned between and adjoining the front plate and the back plate, wherein the corrugating element defines a plurality of voids; and
at least one fill material filling the plurality of voids.

28. A method for producing an armor layer, the method comprising:
providing a first plurality of triangular prism elements, each having an apex and a base;
aligning the first plurality of triangular prism elements such that the bases are coplanar and the apexes are parallel to one another;
placing a reinforced composite layer on the apexes of the first plurality of triangular prism elements;
providing a second plurality of triangular prism elements, each having an apex and a base;
aligning the second plurality of triangular prism elements such that the bases are coplanar and the apexes are parallel to one another;
pressing the apexes of the second plurality of triangular prism elements against the reinforced composite layer to deform the reinforced composite layer until the apexes of the second plurality of triangular prism elements are coplanar with the bases of the first plurality of triangular prism elements; and thereby forming an armor layer.
